(19) United States
(12) Patent Application Publication
(10) Pub. No.: US 2006/0216551 A1
(43) Pub. Date: Sep. 28, 2006

(54) Perpendicular magnetic recording disk and method of producing same

(75) Inventors: Tatsuya Tanifuji, Tokyo (JP); Noriyuki Kumasaka, Tokyo (JP)

Correspondence Address: BEYER WEAVER & THOMAS, LLP, P.O. BOX 70250, OAKLAND, CA, 94612-0250, US

(73) Assignee: NIHON Microcoating Co., Ltd.

(21) Appl. No.: 11/385,182

(22) Filed: Mar. 20, 2006

(30) Foreign Application Priority Data
Mar. 25, 2005 (JP) 2005-87401

(51) Int. Cl. G11B 5/66; B05D 5/12

(52) U.S. Cl. 428/827; 428/836; 427/127

(57) ABSTRACT

A perpendicular magnetic recording disk is produced by forming a soft magnetic layer on a non-magnetic substrate either directly or through a foundation layer in between, forming texturing marks on the surface of this soft magnetic layer, forming a perpendicular magnetic recording layer on the soft magnetic layer either directly or through an intermediate layer in between, and forming a protective layer on the perpendicular recording layer. A texturing process is carried out such that the average surface roughness of the soft magnetic layer is 0.5 Å-5.0 Å, and the line density of the texturing marks is 30 lines/μm or more.

Priority is claimed on Japanese Patent Application 2005-87401 filed Mar. 25, 2005.

### BACKGROUND OF THE INVENTION

This invention relates to a perpendicular magnetic recording disk for a hard disk device to be installed in a computer, a television, a camera, a telephone set or the like, as well as a method of producing such a disk.

Data processors for recording and reproducing data such as characters, images and sounds are coming to be installed not only in computers but also in apparatus such as televisions, cameras and telephones. Such data processors are now required to have improved processing capabilities (with increased recording capacities) and accuracy in reproduction and to be smaller in size. Data are magnetically recorded on a magnetic recording medium and reproduced therefrom by means of a magnetic head of a data processor.

As disclosed in Japanese Patent Publications Tokkai 2004-362746, 5-266455 and 6-103554, perpendicular magnetic recording disks are coming to be considered as a magnetic recording medium. A perpendicular magnetic recording disk is obtained by forming a soft magnetic layer for improving the efficiency of recording and reproducing data signals and a perpendicular magnetic recording layer comprising a perpendicular magnetic film for recording data signals on a disk-shaped non-magnetic substrate (such as a glass substrate and an aluminum substrate with a Ni—P film plated on the surface) by using a conventionally known thin film technology such as sputtering. In addition to these layers, there may be a non-magnetic layer with functions of improving the crystalline characteristic of the perpendicular magnetic recording layer or controlling the diameters of crystalline particles. For preventing the generation of noise (and spike noise in particular) caused by the shifting of magnetic wall due to a leaked magnetic field, it has been known to divide the soft magnetic layer into an upper layer and a lower layer with a hard magnetic layer sandwiched in between to pin the magnetic wall (as disclosed in Japanese Patent Publication Tokkai 5-266455). For making the reproduction output waveform uniform within the surface of the perpendicular magnetic recording disk (or for improving the modulation characteristic, or uniformity of the reproduction output waveform for one round portion of the recording medium at the time of reproduction), furthermore, it has also been known to carry out a texturing process on the surface of the non-magnetic substrate to form approximately concentric texturing marks in the direction of its circumference, to thereafter form a soft magnetic layer on the surface of this non-magnetic substrate through a hard magnetic layer (also referred to as a bias layer) and to form thereon a perpendicular magnetic recording layer (as disclosed in Japanese Patent Publication Tokkai 6-103554).

Because a texturing process is carried out on the surface of a non-magnetic substrate and the other layers are sequentially formed on the surface of this non-magnetic substrate by using a conventionally known thin film technology such as sputtering, however, there is a problem of protrusions due to abnormal growth and corrosion on the surface of each layer, and in particular on the surface of the soft magnetic layer, and there are also problems that layers such as the perpendicular magnetic recording layer cannot be formed thereon as designed and that the characteristics that are expected at the stage of designing cannot be fully obtained.

### SUMMARY OF THE INVENTION

It is therefore an object of this invention to provide a perpendicular magnetic recording disk having no abnormal protrusions on the surface of the soft magnetic layer, as well as a method of producing such a perpendicular magnetic recording disk.

A perpendicular magnetic recording disk according to this invention, capable of accomplishing the object of this invention described above, may be characterized as comprising a non-magnetic substrate, a soft magnetic layer formed on the surface of this non-magnetic substrate either directly or through a foundation layer, a perpendicular magnetic recording layer formed on the surface of this soft magnetic layer either directly or through an intermediate layer and a protective layer formed on the surface of this perpendicular magnetic recording layer wherein the soft magnetic layer has texturing marks on the surface.

The average surface roughness of the soft magnetic layer is preferably 0.5 Å-5.0 Å, and the line density of the texturing marks is 30 lines/μm or more. It is even more preferable that the average surface roughness of the soft magnetic layer be 0.5 Å-3.0 Å, and the line density of the texturing marks be 60 lines/μm or more.

The soft magnetic layer comprises an amorphous alloy containing at least one substance selected from the group consisting of Fe, Co and Ni and at least one substance selected from the group consisting of Nb, Zr, Cr, Ta, Mo, Ti, B, C and P. The soft magnetic layer may comprise an alloy containing at least one substance selected from the group consisting of Fe, Co and Ni and at least one substance selected from the group consisting of Pt, Nb, Zr, Ti, Cr and Ru.

The surface waviness of the non-magnetic substrate is such that surface height variations with wavelengths in the range of 0.05 mm-0.5 mm are 2 Å or less both in the circumferential and radial directions.

Such a perpendicular magnetic recording disk according to this invention is produced by the steps of forming a soft magnetic layer on a non-magnetic substrate, forming texturing marks on the surface of the soft magnetic layer, forming a perpendicular recording layer on the soft magnetic layer, and forming a protective layer on this perpendicular recording layer. In this method, a foundation layer may be first formed on the surface of the non-magnetic substrate, and the soft magnetic layer may be formed next on the surface of this foundation layer. Similarly, an intermediate layer may be first formed on the surface of the soft magnetic layer and the perpendicular recording layer may be formed next on the surface of this intermediate layer.

The texturing step, or the step of forming texturing marks, is carried out by the steps of rotating the disk with the non-magnetic substrate having the soft magnetic layer formed thereon, supplying polishing slurry on the surface of the soft magnetic layer and pressing a tape on the surface of the soft magnetic layer. The polishing slurry comprises abrading particles and water or a water-based aqueous solution that disperses the abrading particles. The abrading particles are artificial diamond particles including primary particles and secondary particles, the primary particles having diameters equal to or less than 30 nm, the average diameter of the primary particles being 4 nm-10 nm, the secondary particles being each a cluster of a plurality of the primary particles, and the diameters of the secondary particles being 20 nm-150 nm. The polishing slurry contains the abrading particles in an amount of 0.001 weight %-0.5 weight %. The water-based aqueous solution comprises water and an additive that comprises a material of one or more kinds selected from the group consisting of glycol compounds, amides of higher aliphatic acid, organic esters of phosphoric acid and non-ionic surfactants, the polishing slurry containing this additive in an amount of 0.5 weight %-5.0 weight %. The tape comprises a woven cloth or a non-woven cloth, having a surface portion that comprises fibers with diameters 0.1 μm-2.0 μm. The pH value of the polishing slurry is pH8.0-pH11.0.

By a method of this invention, the surface of the soft magnetic layer is properly textured such that the perpendicular magnetic recording layer can be formed as intended by its design.

### BRIEF DESCRIPTION OF THE DRAWINGS

FIGS. 1A and 1B are each a sectional view of a perpendicular magnetic recording disk embodying this invention.

FIG. 2 is a computer-generated image by means of an atomic force microscope of the surface of the soft magnetic layer after the texturing process (Test Example 1).

FIG. 3 is a computer-generated image by means of an atomic force microscope of the surface of the soft magnetic layer after the texturing process (Test Example 2).

FIG. 4 is a computer-generated image by means of an atomic force microscope of the surface of the soft magnetic layer after the texturing process (Test Example 3).

FIGS. 5A and 5B are respectively a computer-generated image by means of an atomic force microscope of the surface of the glass substrate after the texturing process and of the soft magnetic layer (Comparison Example 1).

FIGS. 6A and 6B are respectively a computer-generated image by means of an atomic force microscope of the surface of the glass substrate after the texturing process and of the soft magnetic layer (Comparison Example 2).

FIG. 7 shows a texturing device of the kind for texturing both surfaces of a disk at the same time.

### DETAILED DESCRIPTION OF THE INVENTION

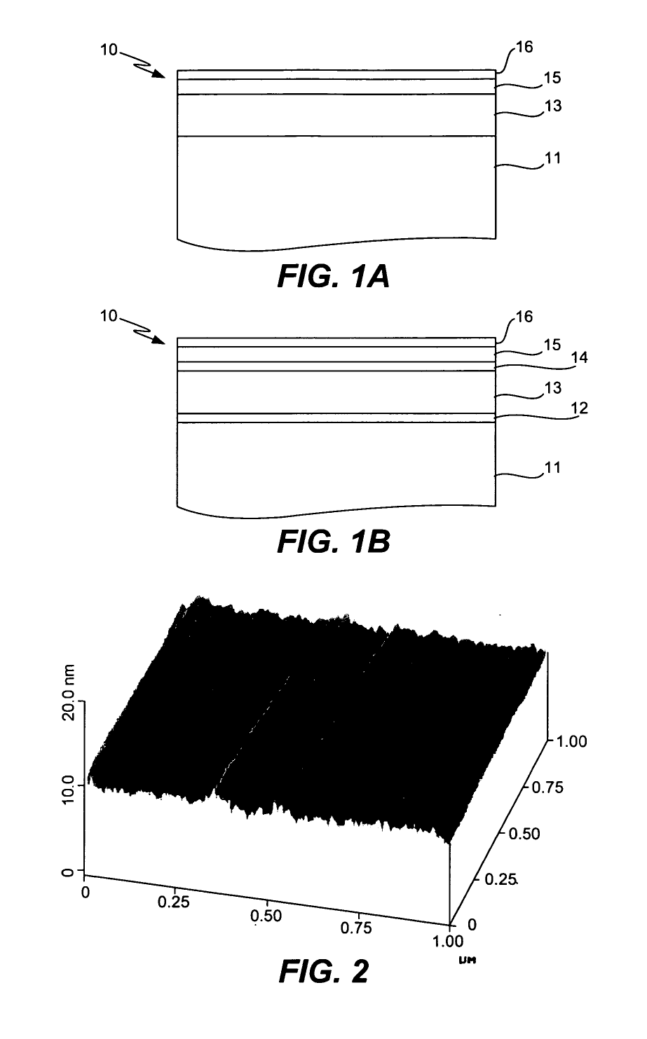

FIG. 1A shows a perpendicular magnetic recording disk 10 embodying this invention having a non-magnetic substrate 11, a soft magnetic layer 13 formed directly on the surface of this non-magnetic substrate 11, a perpendicular magnetic recording layer 15 formed directly on the surface of this soft magnetic layer 13 and a protective layer 16 formed on the surface of this perpendicular magnetic recording layer 15. Alternatively, as shown in FIG. 1B, a foundation layer 12 may be formed on the surface of the non-magnetic substrate 11, the soft magnetic layer 13 being formed on the surface of this foundation layer 12. As still another example, an intermediate layer 14 may be formed on the surface of the soft magnetic layer 13, the perpendicular magnetic recording layer 15 being formed on the surface of this intermediate layer 14. Each of the layers 12-16 on the non-magnetic substrate 11 may be formed by a conventionally known thin film technology such as plating and sputtering.

A glass substrate, an aluminum substrate with the surface subjected to an alumite processing or having a Ni—P film formed by plating, a ceramic substrate or a silicon substrate may be used as the non-magnetic substrate 11.

Both surfaces of the non-magnetic substrate 11 are polished by a known polishing method using free abrading particles (so-called lapping plate polishing method or tape polishing method). The lapping plate polishing method may be effected by rotating a lapping plate with a pad comprising a woven cloth, a non-woven cloth or a foamed material attached to its surface, supplying polishing slurry onto the surface of the lapping plate and pressing the surface of the non-magnetic substrate such that each surface of the non-magnetic substrate will be polished at one time. Alternatively, the non-magnetic substrate may be sandwiched between an upper lapping plate and a lower lapping plate, each having a pad comprising a woven cloth, a non-woven cloth or a foamed material attached to its surface, supplying polishing slurry between these lapping plates and causing each lapping plate to move relative to the non-magnetic substrate such that both surfaces of the non-magnetic substrate will be polished at the same time. After the polishing process, both surfaces of the non-magnetic substrate are washed thoroughly with water and then dried.

Both surfaces of the non-magnetic substrate 11 are made flat by the free particle polishing process. Since polishing of the kind capable of correcting surface waviness is difficult by the texturing process (to be described below) on the surface of the soft magnetic layer 13, it is desirable that the surface waviness of the non-magnetic substrate 11 after this polishing process be such that the surface height variations with wavelengths in the range of 0.05 mm-0.5 mm be 2 Å or less in the circumferential direction and that the surface height variations with wavelengths in the range of 0.05 mm-0.5 mm be 2 Å or less in the radial direction.

The soft magnetic layer 13 comprises an amorphous alloy including at least one substance selected from Fe, Co and Ni and at least one substance selected from Nb, Zr, Cr, Ta, Mo, Ti, B, C and P such as Co—Nb—Zr, Co—Ta—Zr, Co—Ti—Si, Co—Mo—Zr, Fe—Co—P, Ni—P, Fe—Ni—P, Fe—B, Fe—C and Fe—Si. The soft magnetic layer 13 may also comprise an alloy including at least one substance selected from Fe, Co and Ni and at least one substance selected from Pt, Nb, Zr, Ti, Cr and Ru such as Ni—Fe, Fe—Co—Ni, Fe—Co—Ni—Ru, Fe—C—Ru, Fe—Co—Pt, Fe—C—Cr and Fe—Si—Ru.

The soft magnetic layer 13 is formed either directly or through a foundation layer 12 on the surface of the non-magnetic substrate which has been made flat as explained above. If the non-magnetic substrate is an aluminum substrate with a Ni—P film formed on its surface, a magnetic film of Ni—P may be further formed by plating and the soft magnetic layer 13 may be directly formed thereon. The thickness of the soft magnetic layer 13 is within the range of 0.1 μm-0.3 μm.

The foundation layer 12 comprises a material selected from Ti, Cr and their alloys and serves to compensate for the topological unevenness of the surface of the non-magnetic substrate 11 after the polishing process. A hard magnetic layer made of a material such as Co—Sm and Co—Pt may be formed as the foundation layer 12 on the surface of the non-magnetic substrate 11 for magnetic wall pining to eliminate spike noise and to limit the movement of magnetic walls.

The soft magnetic layer 13 has texturing marks on its surface. The average surface roughness (Ra) of the soft magnetic layer 13 is preferably in the range of 0.5 Å-5.0 Å, the line density of the texturing marks being 30 lines/μm or more. More preferably, the average surface roughness of the soft magnetic layer 13 is in the range of 0.5 Å-3.0 Å, the line density of the texturing marks being 60 lines/μm or more. The maximum surface roughness (Rmax) of the soft magnetic layer 13 is 20 times the aforementioned average surface roughness or less. Such texturing marks are formed by a texturing process to be described below. It is thoroughly washed with water after the texturing process and then dried.

The perpendicular magnetic recording layer 15 is formed on the surface of this soft magnetic layer 13 either through an intermediate layer 14 with thickness in the range of 3 nm-30 nm or directly. The intermediate layer 14 is of a material selected from Ta, Ru, Ti, Ge, Si and their alloys. It is formed for the purposes of compensating for the topological unevenness of the surface of the soft magnetic layer 13 after the texturing process, orienting the columnar crystal elements of the perpendicular magnetic recording layer 15 perpendicularly to the surface of the non-magnetic substrate 11 and further optimizing the growth of the crystal.

The perpendicular magnetic recording layer 15 is selected from a material having perpendicular magnetic anisotropy such as Co—Cr, Co—Pt, Co—Cr—Pt, Co—Ni, Co—O and Co—Cr—Pt.SiO₂ (granular structure). Its thickness is in the range of 10 nm-100 nm.

The perpendicular magnetic recording disk 10 is produced by forming the soft magnetic layer 13 on the non-magnetic substrate 11, forming texturing marks on the surface of this soft magnetic layer 13, thereafter forming the perpendicular magnetic recording layer 15 and forming the protective layer 16. The soft magnetic layer 13 may be formed, after the foundation layer 12 is formed on the surface of the non-magnetic substrate 11, on the surface of this foundation layer 12. The perpendicular magnetic recording layer 15 may be formed, after the intermediate layer 14 is formed on the surface of the soft magnetic layer 13, on the surface of this intermediate layer 14. The texturing marks are formed on the surface of the soft magnetic layer 13 as will be described below. The texturing process is carried out on each of the soft magnetic layers 13 formed on both surfaces of the non-magnetic substrate 11. The texturing process may be carried out on one surface at a time or on both surfaces at the same time.

Although the thickness of the soft magnetic layer 13 is in the range of 0.1 μm-0.3 μm, as explained above, this film is formed, say, by sputtering to the thickness of 0.2 μm-0.5 μm in view of this texturing process.

Next, the process for working on both surfaces at the same time is explained as a representative process.

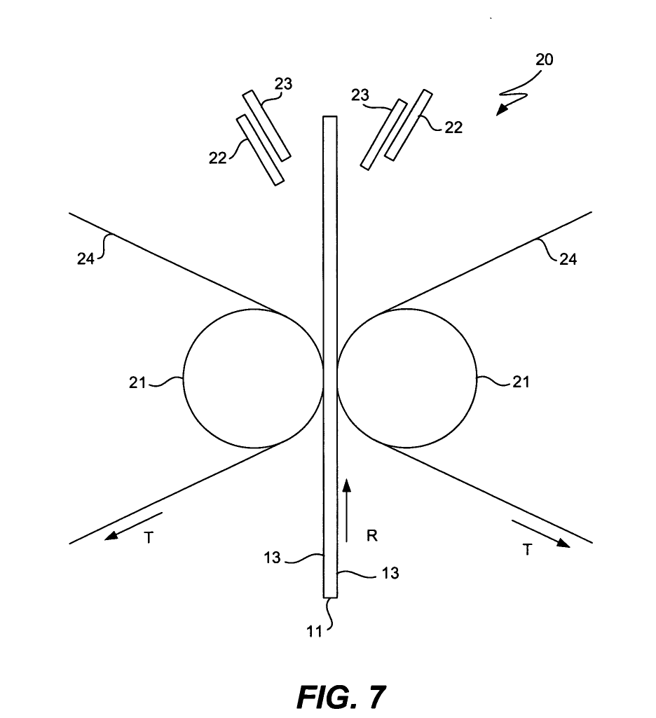

A texturing device 20 such as shown in FIG. 7 may be used for the texturing process. For the texturing process, the target disk with the soft magnetic layer 13 formed on each of the surfaces of the non-magnetic substrate 11 is rotated in the direction shown by arrow R, and polishing slurry is applied onto the surface of each of the soft magnetic layers 13 through nozzles 22. A tape 24 is pressed to the surface of each soft magnetic layer 13 by means of a contact roller 21 and these tapes 24 are advanced in the opposite directions to the rotation of the disk as shown by arrows T. After this texturing process, a washing liquid such as water is applied through nozzles 23 onto the surface of each of the soft magnetic layers 13 for a washing process. The polishing slurry comprises abrading particles and water or a water-based aqueous solution for dispersing these abrading particles. Artificial diamond particles with primary particles having diameters equal to or less than 30 nm and average diameter in the range of 4 nm-10 nm and secondary particles that are each a cluster of a plurality of primary particles, having diameters in the range of 20 nm-150 nm (and preferably in the range of 30 nm-100 nm) may be used as the abrading particles. If the diameters of the secondary particles exceed 150 nm, the surface roughness of the soft magnetic layer becomes too large.

Artificial diamond particles as described above may be obtained by a conventionally known shock wave method (also known as explosion synthesis method) (such as disclosed in Japanese Patent Publication Tokkai 2000-136376). The shock wave method is a method by which diamond powders are artificially obtained by subjecting a material comprising graphite powder to a shock wave and a high pressure at a high temperature and thereafter removing impurities. By this method, diamond particles with density 3.1 g/cm³-3.4 g/cm³ (compared to 3.51 g/cm³ which is the density of natural diamond particles) can be artificially obtained. Artificial diamond particles thus obtained are chemically processed with hydrochloric acid, nitric acid, sulfuric acid and their mixture in order to dissolve the impurities and then washed with water after the impurities are removed. Particles are separated into classes by a centrifuge and collected diamond particles are used as abrading particles.

The polishing slurry contains the abrading particles in an amount of 0.001-0.5 weight %, and preferably 0.005-0.1 weight %. If the content is less than 0.001 weight %, the polishing power becomes insufficient such that it takes too long for the polishing and the undesirable unevenness is formed on the surface of the soft magnetic layer. If the content of the abrading particles exceeds 0.1 weight %, on the other hand, texturing lines come to be formed unevenly. If it further exceeds 0.5 weight %, the maximum surface roughness (Rmax) of the soft magnetic layer becomes more than 20 times as great as the average surface roughness (Ra).

The water-based aqueous solution mentioned above is formed with water and an additive. As the additive, one or more kinds of materials selected from glycol compounds, amides of higher aliphatic acid, organic esters of phosphoric acid and non-ionic surfactants are used.

Since glycol compounds have affinity with the abrading particles and function as a dispersant, they can be used to uniformly prepare a water-based aqueous solution. Glycol compounds are also hydrophilic and can easily wash off the polishing slurry from the surface of the soft magnetic layer after the texturing process. Alkylene glycol, polyethylene glycol, polypropylene glycol and diethyleneglycol butylether can be used as glycol compound.

Amides of higher aliphatic acid function as an polishing accelerator for improving the polishing rate. Examples of amide of higher aliphatic acid include oleic acid diethanol amide, stearic acid diethanol amide, lauric acid diethanol amide, recinoleic acid diethanol amide, recinoleic acid isopropanol amide, erucic acid diethanol amide, tol aliphatic acid diethanol amide but those having 12-22 carbon atoms are preferred.

Organic esters of phosphoric acid are esters obtained by replacing the hydrogen of phosphoric acid (H₃PO₄) with an alkyl group and have the function of inhibiting the generation of abnormal protrusions (burrs formed by debris of polishing attaching to the surface of the soft magnetic layer) on the surface of the soft magnetic layer. Examples of organic ester of phosphoric acid include salts of aliphatic acid and aromatic salts such as phosphate of polyoxyethylene nonylphenol ether.

Non-ionic surfactants have the function of improving the dispersive characteristic of the abrading particles.

The polishing slurry is produced by adding the abrading particles to pure water, using ultrasonic vibrations to disperse the abrading particles, thereafter adding the additive, and again using ultrasonic vibrations to disperse the abrading particles. The pH value of the polishing slurry is in the range of pH8.0-pH11.0 for preventing corrosion of the soft magnetic layer.

A tape with at least its surface part which will actually work on the soft magnetic layer made of woven or non-woven cloth of fibers with diameters in the range of 0.1 μm-2.0 μm is used as the tape used in the texturing process. Fibers such as polyester fibers and nylon fibers are used. Relatively soft nylon fibers and non-woven, non-textured tapes are preferred.

During the polishing process, as the secondary particles of the abrading particles are pressed to the surface of the soft magnetic layer by the fibers of the tape, they break up into smaller secondary particles or primary particles and the latter particles serve to act on the surface of the soft magnetic layer. If the fiber diameters are less than 0.1 μm, the number of contact points between the surface portion of the tape and the abrading particles in the polishing slurry becomes smaller and the abrading particles cannot sufficiently act on the surface of the soft magnetic layer. If the fiber diameters exceed 2.0 μm, on the other hand, the step differences between the fibers forming the surface portion of the tape become too large and the surface of the soft magnetic layer cannot be processed uniformly.

Next, the invention is described by way of test examples and comparison examples.

### TEST EXAMPLE 1

Soft magnetic layers were formed on both surfaces of a non-magnetic substrate according to this invention and their surfaces were textured. A glass substrate with diameter 2.5 inches was used as the non-magnetic substrate. The average surface roughness (Ra) of this glass substrate was 2.0 Å-5.0 Å and the surface height variations with wavelengths in the range of 0.05 mm-0.5 mm both in the circumferential and radial directions were 1.0 Å-2.0 Å on both surfaces. This glass substrate was set inside the chamber of a magnetron sputtering device and after Cr films of thickness 20 nm were initially formed as foundation layers on both surfaces of the glass substrate, Co—Nb—Zr films of thickness 300 nm were formed as soft magnetic layers.

A texturing device as shown in FIG. 7 was used under conditions shown in Table 1 to texture surfaces of the soft magnetic layers formed on both surfaces of the glass substrate. FIG. 2 (a computer-generated image by an atomic force microscope) shows the surface condition of the soft magnetic layer after the texturing process.

TABLE 1

| | | |
|---|---|---|
| Rotational speed of the substrate | 400 | rpm |
| Traveling speed of tapes | 5 | inches/minute |
| Supply rate of polishing slurry | 15 | ml/minute |
| Hardness of contact roller (rubber) | 45 | duro |
| Pressure by contact roller | 5 | pounds |
| Oscillation (total amplitude) | 5 | Hz |
| Texturing time | 20 | seconds |

The tapes that were used for the texturing were non-woven cloth tapes of thickness 660 μm comprising nylon fibers with fiber diameter of 2.0 μm. The composition of the polishing slurry was as shown in Table 2, and the polishing slurry was produced by adding artificial diamond particles obtained by a shock wave method as the abrading particles to pure water, dispersing them by using ultrasonic vibrations (the average particle diameter D50 of the secondary particles of the artificial diamond particles after the dispersion being 80 nm), adding an additive thereto, stirring the mixture and using ultrasonic vibrations again to disperse the abrading particles.

TABLE 2

| | | | |
|---|---|---|---|
| Composition of | Diamond particles | 0.01 | weight % |
| polishing | Additive | 2.0 | weight % |
| slurry | Pure water | 97.99 | weight % |
| Composition of | Glycol compounds | 70 | weight % |
| additive | Amides of higher | 10 | weight % |
| | aliphatic acid | | |
| | Organic esters of | 10 | weight % |
| | phosphoric acid | | |
| | Non-ionic surfactants | 10 | weight % |

### TEST EXAMPLE 2

Soft magnetic layers were formed on both surfaces of a non-magnetic substrate according to this invention and their surfaces were textured. An aluminum substrate with diameter 2.5 inches having Ni—P films plated on the surfaces was used as the non-magnetic substrate. The average surface roughness (Ra) of this aluminum substrate was 2.0 Å-5.0 Å and the surface height variations with wavelengths in the range of 0.05 mm-0.5 mm both in the circumferential and radial directions were 1.0 Å-2.0 Å on both surfaces. This aluminum substrate was set inside the chamber of a magnetron sputtering device and after Cr films of thickness 20 nm were initially formed as foundation layers on both surfaces of the glass substrate, Co—Nb—Zr films of thickness 300 nm were formed as soft magnetic layers.

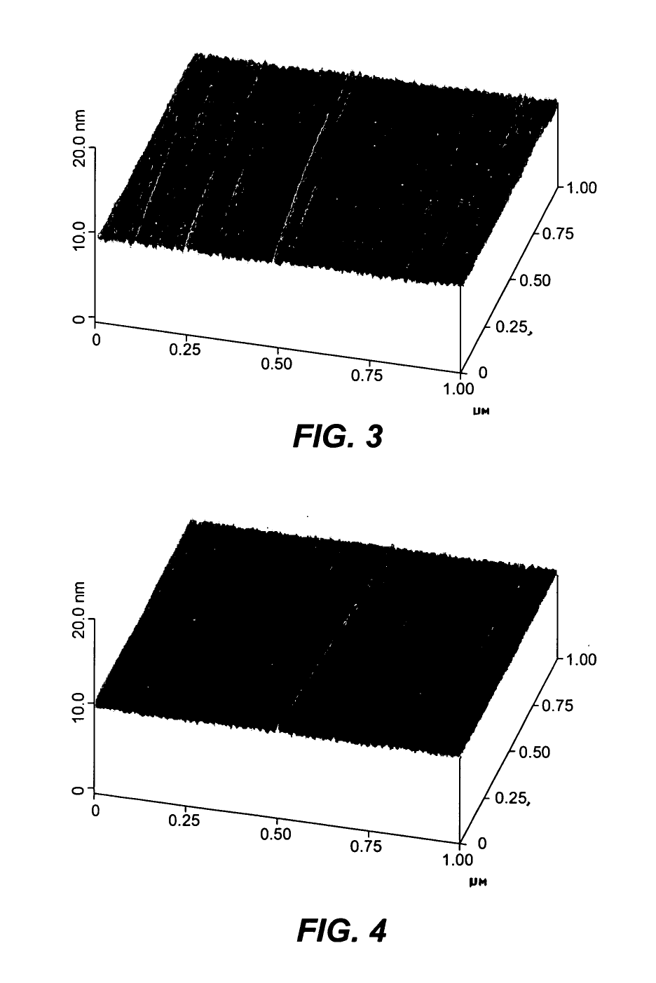

A texturing device as shown in FIG. 7 was used under conditions shown in Table 1 to texture surfaces of the soft magnetic layers formed on both surfaces of the glass substrate. FIG. 3 (a computer-generated image by an atomic force microscope) shows the surface condition of the soft magnetic layer after the texturing process.

The tapes that were used for the texturing were non-woven cloth tapes of thickness 660 μm comprising nylon fibers with fiber diameter of 2.0 μm. The composition of the polishing slurry was as shown in Table 2, and the polishing slurry was produced by adding artificial diamond particles obtained by a shock wave method as the abrading particles to pure water, dispersing them by using ultrasonic vibrations (the average particle diameter D50 of the secondary particles of the artificial diamond particles after the dispersion being 50 nm), adding an additive thereto, stirring the mixture and using ultrasonic vibrations again to disperse the abrading particles.

### TEST EXAMPLE 3

Soft magnetic layers were formed on both surfaces of a non-magnetic substrate according to this invention and their surfaces were textured. A glass substrate with diameter 2.5 inches was used as the non-magnetic substrate. The average surface roughness (Ra) of this glass substrate was 2.0 Å-5.0 Å and the surface height variations with wavelengths in the range of 0.05 mm-0.5 mm both in the circumferential and radial directions were 1.0 Å-2.0 Å on both surfaces. This glass substrate was set inside the chamber of a magnetron sputtering device and after Cr films of thickness 20 nm were initially formed as foundation layers on both surfaces of the glass substrate, Co—Nb—Zr films of thickness 300 nm were formed as soft magnetic layers.

A texturing device as shown in FIG. 7 was used under conditions shown in Table 1 except that the rotational speed of the substrate was changed to 1600 rpm (4 times as fast as in Test Example 1) to texture surfaces of the soft magnetic layers formed on both surfaces of the glass substrate. FIG. 4 (a computer-generated image by an atomic force microscope) shows the surface condition of the soft magnetic layer after the texturing process.

The tapes that were used for the texturing were non-woven cloth tapes of thickness 660 μm comprising nylon fibers with fiber diameter of 2.0 μm. The composition of the polishing slurry was as shown in Table 2, and the polishing slurry was produced by adding artificial diamond particles obtained by a shock wave method as the abrading particles to pure water, dispersing them by using ultrasonic vibrations (the average particle diameter D50 of the secondary particles of the artificial diamond particles after the dispersion being 50 nm), adding an additive thereto, stirring the mixture and using ultrasonic vibrations again to disperse the abrading particles.

### COMPARISON EXAMPLE 1

Soft magnetic layers were formed after both surfaces of a non-magnetic substrate were textured. A glass substrate with diameter 2.5 inches was used as the non-magnetic substrate. The average surface roughness (Ra) of this glass substrate was 2.0 Å-5.0 Å and the surface height variations with wavelengths in the range of 0.05 mm-0.5 mm both in the circumferential and radial directions were 1.0 Å-2.0 Å on both surfaces, as in Test Example 1.

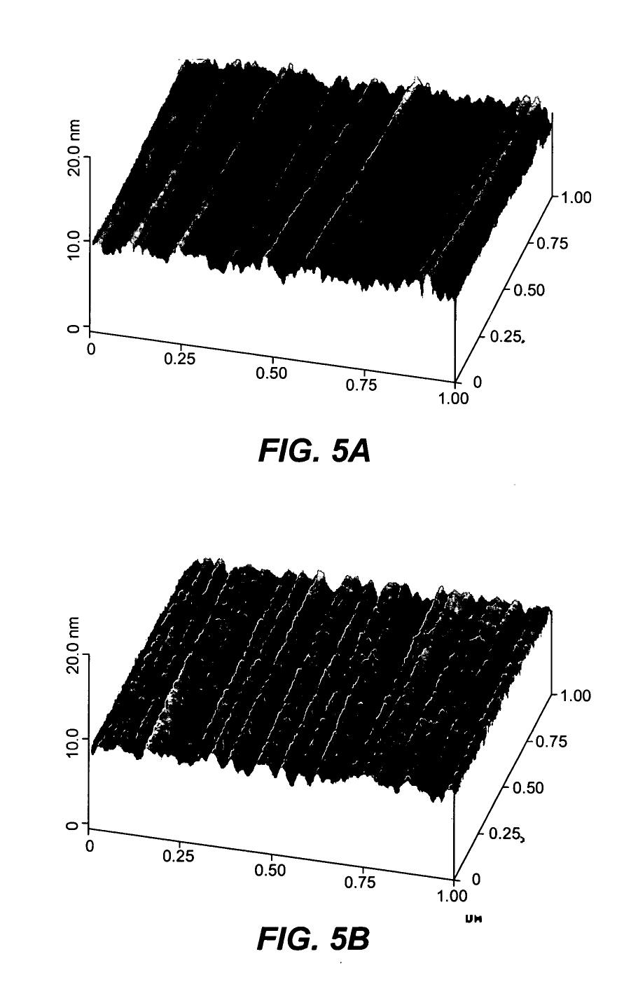

A texturing device as shown in FIG. 7 was used under conditions shown in Test Example 1 to texture both surfaces of the glass substrate. FIG. 5A (a computer-generated image by an atomic force microscope) shows the surface condition of the glass substrate after the texturing process.

This glass substrate was set inside the chamber of a magnetron sputtering device and after Cr films of thickness 20 nm were initially formed as foundation layers on both surfaces of the glass substrate, Co—Nb—Zr films of thickness 200 nm were formed as soft magnetic layers. FIG. 5B (a computer-generated image by an atomic force microscope) shows the surface condition of the soft magnetic layer.

### COMPARISON EXAMPLE 2

Soft magnetic layers were formed after both surfaces of a non-magnetic substrate were textured. An aluminum substrate with diameter 2.5 inches having Ni—P films plated on the surfaces was used as the non-magnetic substrate. The average surface roughness (Ra) of this aluminum substrate was 2.0 Å-5.0 Å and the surface height variations with wavelengths in the range of 0.05 mm-0.5 mm both in the circumferential and radial directions were 1.0 Å-2.0 Å on both surfaces, as in Test Example 2.

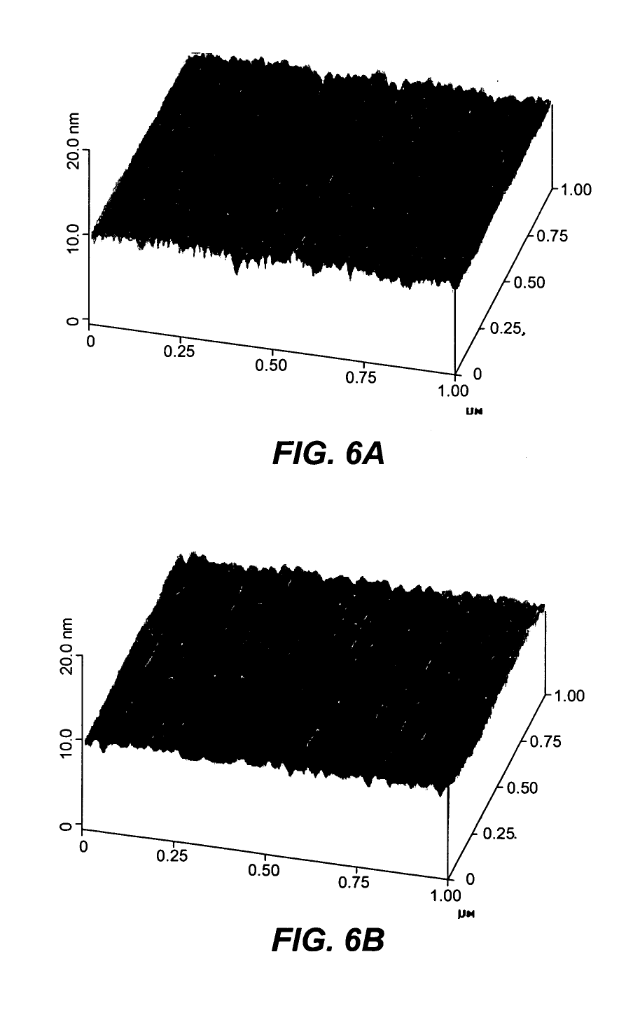

A texturing device as shown in FIG. 7 was used under conditions shown in Test Example 2 to texture both surfaces of the glass substrate. FIG. 6A (a computer-generated image by an atomic force microscope) shows the surface condition of the aluminum substrate after the texturing process.

This glass substrate was set inside the chamber of a magnetron sputtering device and after Cr films of thickness 20 nm were initially formed as foundation layers on both surfaces of the aluminum substrate, Co—Nb—Zr films of thickness 200 nm were formed as soft magnetic layers. FIG. 6B (a computer-generated image by an atomic force microscope) shows the surface condition of the soft magnetic layer.

Comparison Experiments

The surfaces of the soft magnetic layers of Test Examples 1, 2 and 3 after the texturing and those of the non-magnetic substrates after the texturing and the soft magnetic layers of Comparison Examples 1 and 2 were investigated regarding average surface roughness (Ra), maximum height of protrusions (Rmax), number of scratches and number of particles.

The average surface roughness (Ra) was measured by means of an atomic force microscope (Product name: Dimensions 3100 series, produced by Digital Instruments Co.). The computer-generated three-dimensional images in the figures were obtained by using this atomic force microscope. Probes of mono-crystal silicon with radius of curvature 5-10 nm (Product name: D-NCH, produced by Nippon Beaco, Inc.).

Surface height variations with wavelengths in the range of 0.05 mm-0.5 mm in circumferential and radial directions were measured by means of a white light microscope (Product name: New View 5020, produced by Zygo Co.) over an arbitrarily selected area of 0.87 mm×0.65 mm of a non-magnetic substrate.

The numbers of scratches and particles were measured by using a disk surface observation device (Product Name: MicroMaX VMX-2100, produced by Vision Sitec, Ltd.) and averaging the counted numbers.

Results of Experiments

Table 3 summarizes the results of the experiments.

TABLE 3

| | | | Maximum | | | |
|---|---|---|---|---|---|---|
| | | | surface | | | |
| | Average surface | | roughness | Line density | Number of | Number of |
| | roughness (Ra) | | (Rmax) | (lines/μm) | scratches | particles |
| Test Example 1 | 2.9 | | 34.4 | 35 | A | A |
| Test Example 2 | 1.9 | | 24.2 | 72 | A | A |
| Test Example 3 | 0.94 | | 9.8 | 122 | A | A |
| Comparison | Non-magnetic | 3.0 | 36.5 | 32 | A | A |
| Example 1 | substrate | | | | | |
| | Soft magnetic | 4.5 | 47.1 | 28 | B | B |
| | layer | | | | | |
| Comparison | Non-magnetic | 2.8 | 42.2 | 45 | A | A |
| Example 2 | substrate | | | | | |
| | Soft magnetic | 3.2 | 46.0 | 46 | B | B |
| | layer | | | | | |

Regarding the number of scratches in Table 3, “A” indicates “less than 10/surface” and “B” indicates “10 or more/surface.” Regarding the number of particles (attached debris), “A” indicates “less than 20/surface” and “B” indicates “20 or more/surface”.

As shown in FIG. 3, the average surface roughness of the non-magnetic substrate is low in Comparison Examples 1 and 2 but after a soft magnetic layer is formed on the non-magnetic substrate, the average surface roughness of the soft magnetic layer becomes high. Moreover, undesirable scratches are formed on the surface of the soft magnetic layer and many debris particles become attached. According to the present invention, by contrast, the average surface roughness of the soft magnetic layer is low and the number of scratches that are formed and the number of debris particles that become attached are both small. Since there are no abnormal protrusions exceeding 40 Å, layers that are formed thereon such as the perpendicular magnetic recording layer can be obtained as designed.

What is claimed is:

1. A perpendicular magnetic recording disk comprising:
a non-magnetic substrate;
a soft magnetic layer formed on the surface of said non-magnetic substrate either directly or through a foundation layer;
a perpendicular magnetic recording layer formed on the surface of said soft magnetic layer either directly or through an intermediate layer; and
a protective layer formed on the surface of said perpendicular magnetic recording layer;
wherein said soft magnetic layer has texturing marks on the surface.

2. The perpendicular magnetic recording disk of claim 1 wherein the average surface roughness of said soft magnetic layer is 0.5 Å-5.0 Å, and the line density of said texturing marks is 30 lines/μm or more.

3. The perpendicular magnetic recording disk of claim 1 wherein the average surface roughness of said soft magnetic layer is 0.5 Å-3.0 Å, and the line density of said texturing marks is 60 lines/μm or more.

4. The perpendicular magnetic recording disk of claim 1 wherein said soft magnetic layer comprises an amorphous alloy containing at least one substance selected from the group consisting of Fe, Co and Ni and at least one substance selected from the group consisting of Nb, Zr, Cr, Ta, Mo, Ti, B, C and P.

5. The perpendicular magnetic recording disk of claim 1 wherein said soft magnetic layer comprises an alloy containing at least one substance selected from the group consisting of Fe, Co and Ni and at least one substance selected from the group consisting of Pt, Nb, Zr, Ti, Cr and Ru.

6. The perpendicular magnetic recording disk of claim 1 wherein the surface waviness of said non-magnetic substrate is such that surface height variations with wavelengths in the range of 0.05 mm-0.5 mm are 2 Å or less both in the circumferential and radial directions.

7. A method of producing a perpendicular magnetic recording disk, said method comprising the steps of:
forming a soft magnetic layer on a non-magnetic substrate;
forming texturing marks on the surface of said soft magnetic layer;
forming a perpendicular recording layer on said soft magnetic layer; and
forming a protective layer on said perpendicular recording layer.

8. The method of claim 7 wherein said step of forming the soft magnetic layer includes the steps of:
forming a foundation layer on the surface of said non-magnetic substrate; and
forming said soft magnetic layer on the surface of said foundation layer.

9. The method of claim 7 wherein said step of forming the perpendicular recording layer includes the steps of:
forming an intermediate layer on the surface of said soft magnetic layer; and
forming said perpendicular recording layer on the surface of said intermediate layer.

10. The method of claim 7 wherein said step of forming texturing marks includes the steps of:
rotating the disk with said non-magnetic substrate having said soft magnetic layer formed thereon;
supplying polishing slurry on the surface of said soft magnetic layer; and
pressing a tape on the surface of said soft magnetic layer; and
wherein said polishing slurry comprises abrading particles and water or a water-based aqueous solution that disperses said abrading particles, said abrading particles being artificial diamond particles including primary particles and secondary particles, said primary particles having diameters equal to or less than 30 nm, the average diameter of said primary particles being 4 nm-10 nm, said secondary particles being each a cluster of a plurality of the primary particles, the diameters of said secondary particles being 20 nm-150 nm.

11. The method of claim 10 wherein said polishing slurry contains said abrading particles in an amount of 0.001 weight %-0.5 weight %.

12. The method of claim 10 wherein said water-based aqueous solution comprises water and an additive that comprises a material of one or more kinds selected from the group consisting of glycol compounds, amides of higher aliphatic acid, organic esters of phosphoric acid and non-ionic surfactants, said polishing slurry containing said additive in an amount of 0.5 weight %-5.0 weight %.

13. The method of claim 10 wherein said tape comprises a woven cloth or a non-woven cloth, said tape having a surface portion that comprises fibers with diameters 0.1 μm-2.0 μm.

14. The method of claim 10 wherein the pH value of said polishing slurry is pH8.0-pH11.0.

15. The method of claim 7 wherein the average surface roughness of said soft magnetic layer after being textured is 0.5 Å-5.0 Å, and the line density of said texturing marks is 30 lines/μm or more.

16. The method of claim 7 wherein the average surface roughness of said soft magnetic layer after being textured is 0.5 Å-3.0 Å, and the line density of said texturing marks is 60 lines/μm or more.
